(19) United States
(12) Patent Application Publication
(10) Pub. No.: US 2025/0189301 A1
(43) Pub. Date: Jun. 12, 2025

(54) MEASUREMENT DEVICE

(71) Applicant: Panasonic Intellectual Property Management Co., Ltd., Osaka (JP)

(72) Inventors: Katsuya NOZAWA, Osaka (JP); Takayuki KIYOHARA, Osaka (JP)

(21) Appl. No.: 18/941,187

(22) Filed: Nov. 8, 2024

(30) Foreign Application Priority Data
Dec. 12, 2023 (JP) 2023-209358

(51) Int. Cl. G01B 11/00; G01B 11/24

(52) U.S. Cl. CPC G01B 11/007; G01B 11/2441

(57) ABSTRACT

A measurement device includes: a first movable component having a mirror; a second movable component having a light emission point, a light entry point, and an optical system; a driving mechanism; and a controller. First light and second light emitted from the light emission point are emitted onto the mirror via the optical system, and first reflected light and second reflected light enter the light entry point via the optical system. The controller causes the driving mechanism to adjust the position of the second movable component, based on an intensity of each of the first reflected light and the second reflected light. A first wavelength that is a peak wavelength of the first light is different from a second wavelength that is a peak wavelength of the second light, and an optical power of the optical system is different at each of the first wavelength and the second wavelength.

### CROSS REFERENCE TO RELATED APPLICATION

The present application is based on and claims priority of Japanese Patent Application No. 2023-209358 filed on Dec. 12, 2023. The entire disclosure of the above-identified application, including the specification, drawings and claims is incorporated herein by reference in its entirety.

### FIELD

The present disclosure relates to a measurement device.

### BACKGROUND

Contact-type three-dimensional shape measuring instruments are used for measuring the shapes of lenses and the like with high accuracy. Patent Literature (PTL) 1 discloses the configuration of an optical probe used in a contact-type three-dimensional shape measuring instrument.

### CITATION LIST

### Patent Literature

PTL 1: Japanese Patent No. 3000819

### SUMMARY

### Technical Problem

The present disclosure provides a measurement device that includes a small, lightweight movable body.

### Solution to Problem

A measurement device according to one aspect of the present disclosure includes: a first movable body including a reflector; a second movable body including a light emission point, a light entry point, and an optical system; a driving mechanism that adjusts a position of the second movable body; and a controller that controls the driving mechanism, in which first light and second light that are emitted from the light emission point are emitted onto the reflector via the optical system, first reflected light and second reflected light enter the light entry point via the optical system, the first reflected light being reflected light of the first light from the reflector, the second reflected light being reflected light of the second light from the reflector, the controller causes the driving mechanism to adjust the position of the second movable body, based on an intensity of each of the first reflected light and the second reflected light that have entered the light entry point, a first wavelength that is a peak wavelength of the first light is different from a second wavelength that is a peak wavelength of the second light, and an optical power of the optical system at the first wavelength is different from an optical power of the optical system at the second wavelength.

### Advantageous Effects

The present disclosure enables providing a measurement device that includes a small, lightweight movable body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an outline configuration of a measurement device according to Embodiment 1.

FIG. 2 illustrates an outline configuration of a measurement device according to a variation of Embodiment 1.

FIG. 3 is a graph illustrating the relationship between the relative positions of the two movable bodies and light intensity.

FIG. 4 is a graph illustrating the relationship between the wavelength of entering light and the focal length of an achromatic lens.

FIG. 5 illustrates an outline configuration of a measurement device according to Embodiment 2.

FIG. 6 illustrates an outline configuration of a conventional three-dimensional shape measuring instrument.

### DESCRIPTION OF EMBODIMENTS

### Overview of Present Disclosure

The present inventors have found that the following problems occur regarding the optical probe used in the three-dimensional shape measuring instrument disclosed in PTL 1. Below, the problems of the conventional optical probe are described with reference to the configuration of the optical probe disclosed in PTL 1.

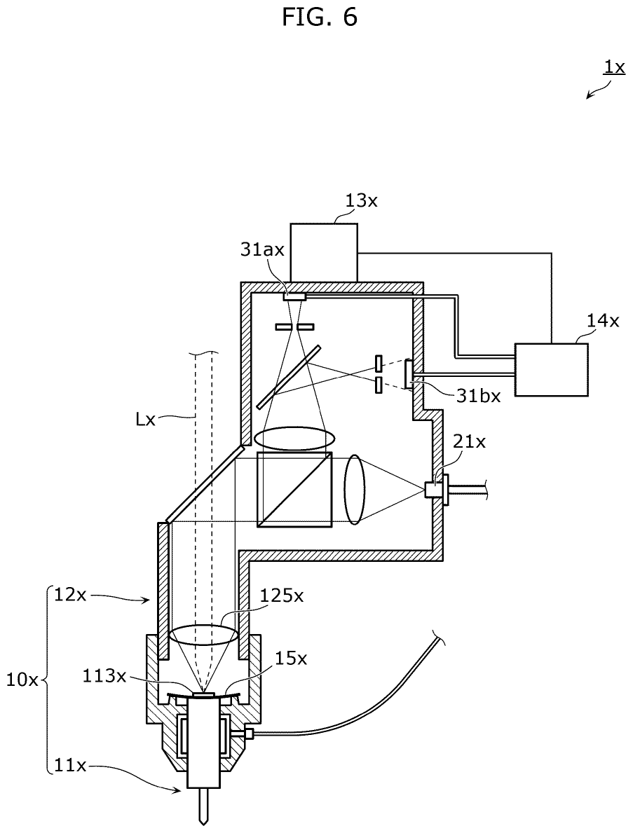

FIG. 6 illustrates an outline configuration of the conventional three-dimensional shape measuring instrument. As illustrated in FIG. 6, three-dimensional shape measuring instrument 1x includes optical probe 10x. Optical probe 10x is composed of the two elements of movable component 11x and movable component 12x.

Movable component 11x moves up and down following the shape of a measurement target (not shown). Three-dimensional shape measuring instrument 1x emits light Lx (shown in FIG. 6 as a broken line) onto movable component 11x from outside of optical probe 10x, and the position of movable component 11x is determined based on the reflected light. Three-dimensional shape measuring instrument 1x thus obtains shape information regarding the measurement target.

Movable component 12x has the function of restricting the motion of movable component 11x to the up-down direction. Further, movable component 11x and movable component 12x are coupled by means of spring 15x. In order to maintain contact strength between movable component 12x and the measurement target within a certain range, the relative positions of movable component 11x and movable component 12x must be made to fall within a certain range.

Moreover, in the configuration of PTL 1, object lens 125x is disposed on movable component 12x. Object lens 125x condenses light that has entered from outside of optical probe 10x to mirror 113x in movable component 11x. Object lens 125x transmits the reflected light from mirror 113x to a laser measuring instrument (not shown) outside of optical probe 10x. In order for the reflected light to return to the laser measuring instrument, mirror 113x of movable component 11x must be positioned near the focal position of object lens 125x of movable component 12x. In this sense as well, optical probe 10x necessitates making the relative positions of movable component 11x and movable component 12x fall within a certain range.

Movable component 12x includes semiconductor laser 21x and light detectors 31ax and 31bx as means for measuring the relative positions of movable component 11x and movable component 12x. The reason for movable component 12x including the two light detectors 31ax and 31bx is that each of detectors 31ax and 31bx has a different dependence on the relative positions of movable component 11x and movable component 12x. Due to this configuration, in a case of deviation from the desired relative positions, it is possible to calculate in which direction and to what extent to move movable component 12x in order to reach the desired relative positions.

As illustrated in FIG. 6, the contact-type three-dimensional shape measuring instrument 1x includes driving means 13x and relative position measuring means 14x.

Relative position measuring means 14x calculates the relative positions of movable component 11x and movable component 12x based on the output of each of light detectors 31ax and 31bx. Driving means 13x adjusts the relative positions of movable component 11x and movable component 12x by changing the position of movable component 12x such that certain relative positions are reached.

Three-dimensional shape measuring instrument 1x changes the relative positions of optical probe 10x and the measurement target in the lateral direction in order to measure the three-dimensional shape of the measurement target. In this case, the position of movable component 11x in the up-down direction changes in accordance with the shape of the measurement target. Each time the relative positions in the lateral direction are changed, the relative positions must be measured and the position of movable component 12x must be changed in order to reach certain relative positions between movable component 11x and movable component 12x.

However, if the speed of changing the position of movable component 12x is slow, this limits the speed of the shape measurement. Further, if the positional change falls behind, the relative positions of movable component 11x and movable component 12x deviate from the suitable range. In this case, problems such as the following occur: movable component 11x is excessively pressed against by the measurement target, or movable component 11x moves away from the measurement target and measurement cannot be performed as normal.

The weight of movable component 12x affects the speed of changing the position of movable component 12x. In order to increase the speed of changing the position, there is a need to make movable component 12x as lightweight as possible. Moreover, in order to inhibit the measurement target and movable component 12x from physically interfering with each other, there is a need for movable component 12x to be as small as possible.

Thus, the present disclosure provides a measurement device that includes a small, lightweight movable body.

A measurement device according to a first aspect of the present disclosure includes: a first movable body including a reflector; a second movable body including a light emission point, a light entry point, and an optical system; a driving mechanism that adjusts a position of the second movable body; and a controller that controls the driving mechanism, in which first light and second light that are emitted from the light emission point are emitted onto the reflector via the optical system, first reflected light and second reflected light enter the light entry point via the optical system, the first reflected light being reflected light of the first light from the reflector, the second reflected light being reflected light of the second light from the reflector, the controller causes the driving mechanism to adjust the position of the second movable body, based on an intensity of each of the first reflected light and the second reflected light that have entered the light entry point, a first wavelength that is a peak wavelength of the first light is different from a second wavelength that is a peak wavelength of the second light, and an optical power of the optical system at the first wavelength is different from an optical power of the optical system at the second wavelength.

This makes it possible to make different the intensities of the first reflected light and the second reflected light that enter the light entry point, by using an optical system having different optical power at each of the first wavelength and the second wavelength. Based on this difference in intensity, the relative positions of the first movable body and the second movable body can be calculated and adjusted. This obviates the need to provide a light entry point for each wavelength, making it possible to reduce the elements provided to the second movable body. Thus, it is possible to realize the size reduction and weight reduction of the second movable body.

A measurement device according to a second aspect of the present disclosure is the measurement device according to the first aspect, including: an optical fiber, in which the light emission point and the light entry point are both a first end of the optical fiber.

Accordingly, the light emission point and the light entry point are an end of the optical fiber, which makes it possible to reduce the size and weight of the second movable body. This is because typically, the size of an end of an optical fiber is smaller than that of a semiconductor laser and a light detector, thus making it possible to contribute to reducing the size and weight of the second movable body. Furthermore, in the case of providing an element such as a semiconductor laser, a light detector, or the like, a power line for supplying power to operate the element and a signal line for extracting a signal outputted from the element become necessary In contrast, using the optical fiber obviates the need to provide a power line and a signal line, and makes it possible to reduce the total number of cables connected to the second movable body. In this sense as well, it is possible to realize the size reduction and weight reduction of the second movable body.

A measurement device according to a third aspect of the present disclosure is the measurement device according to the first aspect or the second aspect, in which a wavelength component having a certain intensity or higher in the first light and a wavelength component having a certain intensity or higher in the second light do not overlap each other.

Accordingly, it is only necessary to detect the light intensity at the two wavelengths of the first wavelength and the second wavelength. Compared to a case of performing spectroscopy and carrying out spectral measurement, the quantity and time period of operations can be decreased, making it possible to calculate and adjust the relative positions of the first movable body and the second movable body in a shorter period. Thus, this can contribute to accelerating the measurement of the measurement target.

A measurement device according to a fourth aspect of the present disclosure is the measurement device according to any one of the first aspect to the third aspect, in which light used to measure a target enters the optical system, a third wavelength that is a peak wavelength of the light used to measure the target is different from both the first wavelength and the second wavelength, and an optical power of the optical system at the third wavelength is approximately equal to one of the optical power of the optical system at the first wavelength or the optical power of the optical system at the second wavelength, and is different from an other of the optical power of the optical system at the first wavelength or the optical power of the optical system at the second wavelength.

This facilitates splitting the light used for measurement of the measurement target from the light used for measurement of the relative positions of the first movable body and the second movable body. This enables inhibiting negative effects imparted by the mutual lights, whereby the measurement accuracy of each can be enhanced.

A measurement device according to a fifth aspect of the present disclosure is the measurement device according to the fourth aspect, including an interferometer that produces interference in the light used to measure the target.

Accordingly, the measurement of the surface shape of the measurement target can be taken based on distance measurement utilizing light interference.

A measurement device according to a sixth aspect of the present disclosure is the measurement device according to any one of the first aspect to the fifth aspect, in which a light intensity measurer that measures an intensity of each of the first reflected light and the second reflected light that have entered the light entry point.

This makes it possible to provide a light intensity measurer separately from the second movable body, thereby facilitating replacement when the light intensity measurer has deteriorated.

A measurement device according to a seventh aspect of the present disclosure is the measurement device according to the sixth aspect, in which the light intensity measurer includes: a first photodiode that photoelectrically converts the first reflected light into a first signal and outputs the first signal; a second photodiode that photoelectrically converts the second reflected light into a second signal and outputs the second signal; a first circuit that performs analog-to-digital conversion on the first signal; and a second circuit that is different from the first circuit and performs analog-to-digital conversion on the second signal.

Accordingly, it is only necessary to detect the light intensities at the two wavelengths of the first wavelength and the second wavelength. Compared to a case of performing spectroscopy and carrying out spectral measurement, the quantity and time period of operations can be decreased, making it possible to calculate and adjust the relative positions of the first movable body and the second movable body in a shorter period. Thus, this can contribute to accelerating the measurement of the measurement target.

A measurement device according to an eighth aspect of the present disclosure is the measurement device according to the sixth aspect, in which the light intensity measurer includes: a first photodiode that photoelectrically converts the first reflected light into a first signal and outputs the first signal; a second photodiode that photoelectrically converts the second reflected light into a second signal and outputs the second signal; and a differential operation circuit that receives inputs of each of the first signal and the second signal.

Accordingly, it is only necessary to detect the light intensities at the two wavelengths of the first wavelength and the second wavelength. Compared to a case of performing spectroscopy and carrying out spectral measurement, the quantity and time period of operations can be decreased, making it possible to calculate and adjust the relative positions of the first movable body and the second movable body in a shorter period. Thus, this can contribute to accelerating the measurement of the measurement target.

A measurement device according to a ninth aspect of the present disclosure is the measurement device according to the second aspect, including: a light source component, in which light emitted from the light source component enters from an end of the optical fiber on a side opposite to the first end, is guided along the optical fiber, and is emitted from the first end as the first light and the second light.

Accordingly, it is possible to provide a light source component separately from the second movable body, thereby facilitating replacement when the light source component has deteriorated. Furthermore, it is possible to inhibit degradation of the accuracy of measuring the measurement target resulting from the influence of heat generated by the light source component during light emission.

A measurement device according to a tenth aspect of the present disclosure is the measurement device according to the ninth aspect, in which the light source component includes: a first laser light source that emits the first light; and a second laser light source that is different from the first laser light source and emits the second light.

This makes it possible to utilize separate laser light sources that emit light in accordance with the wavelength.

A measurement device according to an eleventh aspect of the present disclosure is the measurement device according to the ninth aspect, in which the light source component is a laser light source that includes: a first active region that emits the first light; and a second active region that emits the second light.

This makes it possible to have one laser light source, whereby the configuration of the light source component can be simplified.

A measurement device according to a twelfth aspect of the present disclosure is the measurement device according to the ninth aspect, in which the light source component is a gas laser light source that emits the first light and the second light.

This makes it possible to have one laser light source, whereby the configuration of the light source component can be simplified. Furthermore, various light sources can be utilized in the measurement device of the present disclosure, regardless of the principles of laser oscillation.

A measurement device according to a thirteenth aspect of the present disclosure is the measurement device according to any one of the first aspect to the twelfth aspect, in which the optical system includes an achromatic lens.

This makes it possible, due to the achromatic lens, to make the third wavelength of the light used for measurement of the measurement target approximately equal to one of the first wavelength of the first light or the second wavelength of the second light that are used for measurement of the relative positions of the first movable body and the second movable body, and different from the other of the first wavelength of the first light or the second wavelength of the second light. This facilitates splitting the light used for measurement of the measurement target from the light used for measurement of the relative positions of the first movable body and the second movable body. Thus, it is possible to inhibit negative effects imparted by the mutual lights, whereby the measurement accuracy of each can be enhanced.

Hereinafter, certain exemplary embodiments are described in greater detail with reference to the accompanying Drawings.

Each of the exemplary embodiments described below shows a general or specific example. The numerical values, shapes, materials, elements, the arrangement and connection of the elements, steps, the processing order of the steps etc. shown in the following exemplary embodiments are mere examples, and therefore do not limit the scope of the appended Claims and their equivalents. Therefore, among the elements in the following exemplary embodiments, those not recited in any one of the independent claims are described as optional elements.

Furthermore, each Drawing is merely a schematic illustration for the purpose of conceptual explanation, and is not intended to indicate the actual size, shape, and/or the like. Therefore, for example, the scales and the like in the Drawings do not necessarily match. Moreover, in the Drawings, the same reference symbols are appended to elements that are substantially the same, and overlapping descriptions are omitted or simplified.

Furthermore, in the present specification, the light emission point is a part at which light is emitted into the second movable body, and is a part having a certain area. For example, the light emission point is an end of an optical fiber, the light emission face of a light-emitting element, or the like. The light entry point is a part at which light transmitted along the interior of the second movable body enters the light detector, and is a part having a certain area. For example, the light entry point is an end of an optical fiber, a pinhole, or the like.

Furthermore, in the present specification, the “up-down direction” means the direction in which the relative positions of the first movable body and the second movable body can be changed. Specifically, the direction parallel to the axis of a stylus included in the first movable body is the up-down direction. The tip direction along the axis of the stylus is the “downward direction”, and the direction opposite to that is the “upward direction”. The tip of the stylus comes in contact with the measurement target.

Moreover, in the present specification, unless otherwise specified particularly, ordinals such as “first”, “second”, and the like do not indicate the number or order of elements, but are used for the purpose of distinguishing between elements of the same type to avoid confusion.

### Embodiment 1

First, a measurement device according to Embodiment 1 is described. The measurement device according to the present embodiment has a configuration in which, instead of a laser light source and a light detector provided to a movable component, an end of the optical fiber is connected to the movable component.

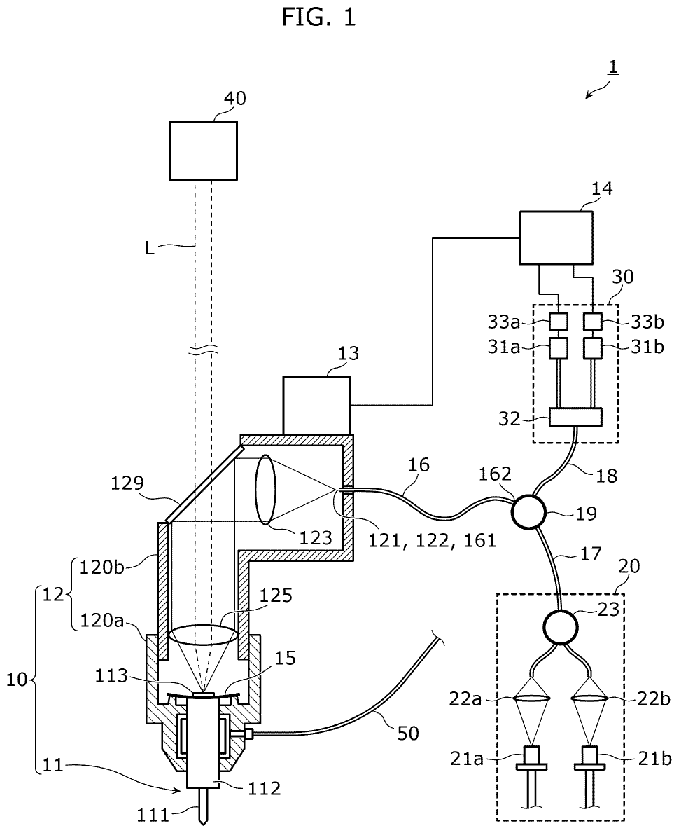

Hereinafter, the specific configuration of the measurement device according to the present embodiment is described with reference to FIG. 1. FIG. 1 illustrates an outline configuration of the measurement device according to the present embodiment.

Measurement device 1 according to the present embodiment is a three-dimensional shape measuring instrument. Specifically, measurement device 1 measures the surface shape of a measurement target (not shown). As illustrated in FIG. 1, measurement device 1 includes probe 10, driving mechanism 13, controller 14, spring 15, optical fibers 16, 17, and 18, and circulator 19. Furthermore, measurement device 1 includes light source component 20, light intensity measurer 30, interferometer 40, and air supplier 50.

### Probe

Probe 10 includes movable component 11 and movable component 12. Movable component 11 is an example of the first movable body that has the reflector. Movable component 12 is an example of the second movable body that has the light emission point, the light entry point, and the optical system.

Movable component 11 has stylus 111, sliding component 112, and mirror 113. Stylus 111 is fixed to sliding component 112. When measuring the measurement target, the tip of stylus 111 comes in contact with the measurement target. In the case in which stylus 111 has come in contact with the measurement target, the position of movable component 11 changes in the up-down direction in accordance with the shape of the measurement target. Sliding component 112 restricts the movement of movable component 11 to the up-down direction. Mirror 113 is an example of the reflector included in the first movable body. The mutual positional relationship between stylus 111, sliding component 112, and mirror 113 is fixed.

Movable component 12 includes guide mechanism 120a and probe housing 120b. The mutual positional relationship between guide mechanism 120a and probe housing 120b is fixed. In the present embodiment, movable component 12 has light emission point 121 and light entry point 122. Light emission point 121 is the same as light entry point 122, and is end 161 of optical fiber 16. Moreover, movable component 12 has the optical system fixed on probe housing 120b.

The optical system includes collimator lens 123, condenser lens 125, and optical element 129.

Collimator lens 123 converts light emitted from light emission point 121 into nearly parallel light (hereinafter, referred to as parallel light). Nearly parallel light means light having a smaller divergence angle than that of light before being incident on collimator lens 123, i.e., in the present embodiment, light emitted from end 161 of optical fiber 16. Furthermore, collimator lens 123 condenses light that has proceeded from the opposite direction, more specifically light that has been reflected by mirror 113, near end 161 of optical fiber 16, which serves as light entry point 122.

Condenser lens 125 condenses incident light to the region of mirror 113. For example, condenser lens 125 condenses parallel light, which has been converted by collimator lens 123 and been reflected by optical element 129, to the region of mirror 113. Furthermore, condenser lens 125 converts light reflected by mirror 113 into parallel light and makes this light incident on collimator lens 123 via optical element 129. Moreover, in the present embodiment, condenser lens 125 condenses light L, used for measurement of the measurement target, to the region of mirror 113. Furthermore, condenser lens 125 converts light L reflected by mirror 113 into parallel light and makes this light enter interferometer 40 via optical element 129.

Optical element 129 is an optical element that has the purpose of overlapping the optical paths of light L, which is used for measurement by interferometer 40, and light for measuring the relative positions of movable component 11 and movable component 12, and making these incident on mirror 113. Furthermore, with respect to reflected light that has been reflected from mirror 113 and passed through condenser lens 125, optical element 129 splits reflected light for entry into interferometer 40, and reflected light for measuring the relative positions of movable component 11 and movable component 12. Optical element 129 is, for example, a dichroic mirror, but may be a half mirror, a beam splitter cube, a polarizing beam splitter cube, or the like.

For example, when the wavelength of light L, which is used by interferometer 40, and the wavelength of the light for measuring the relative positions of movable component 11 and movable component 12 are made different, the paths of both lights can be brought together or nearly completely separated by an optical element having wavelength dependence, such as a dichroic mirror or the like. In the configuration of FIG. 1, a dichroic mirror is used as optical element 129. The dichroic mirror allows the passage of light L, which is used by interferometer 40, and reflects the light for measuring the relative positions of movable component 11 and movable component 12.

Alternatively, when the polarization of light L, which is used by interferometer 40, and the polarization of the light for measuring the relative positions of movable component 11 and movable component 12 are made different, the paths of both lights can be brought together or nearly completely separated by an optical element having polarization dependence, such as a polarizing beam splitter cube or the like. Furthermore, there may be a case of adopting a configuration in which a non-polarizing beam splitter is used for overlapping the optical paths of light L used by interferometer 40, and the light for measuring the relative positions of movable component 11 and movable component 12. In this case, an optical element that allows one light to pass through and shields the other light, such as a notch filter, a bandpass filter, a long pass filter, a short pass filter, or the like, may be provided in the optical path in which to split these lights.

In the present embodiment, the optical system included in movable component 12 may include, aside from collimator lens 123 and condenser lens 125, an optical element having optical power. Furthermore, the present embodiment may also include an optical element that adjusts the optical path such that light that has passed through collimator lens 123 is made incident on condenser lens 125.

In the present embodiment, the light emitted from light emission point 121 includes the first light and the second light. The first light and the second light are emitted onto mirror 113 via the optical system included in movable component 12. Specifically, the first light and the second light are converted into parallel light by collimator lens 123, and are then reflected by optical element 129 and condensed to the region of mirror 113 by condenser lens 125. First wavelength λ₁ that is the peak wavelength of the first light is different from second wavelength λ₂ that is the peak wavelength of the second light.

The reflected light from mirror 113 includes the first reflected light and the second reflected light. The first reflected light is the reflected light of the first light from mirror 113. The second reflected light is the reflected light of the second light from mirror 113. In the present embodiment, the peak wavelength of the first reflected light is the same as the peak wavelength of the first light, and is first wavelength λ₁. The peak wavelength of the second reflected light is the same as the peak wavelength of the second light, and is second wavelength λ₂.

The optical power of the optical system included in movable component 12 at first wavelength λ₁ is different from the optical power of the optical system at second wavelength λ₂. Specifically, within the optical system included in movable component 12, in at least one of the optical elements in the optical path through which the first light and the second light pass, the optical power with respect to first wavelength λ₁ and the optical power with respect to second wavelength λ₂ are different.

Note that the optical power is proportional to the inverse of the focal length. As referred to herein, the two optical powers being different means that the two optical powers are not approximately equal. The two optical powers being approximately equal means a case in which the percentage of the difference in the two optical powers with respect to the greater of the two optical powers is less than 10%. Therefore, the two optical powers being different means a case in which the percentage of the difference in the two optical powers with respect to the greater of the two optical powers is at least 10%.

The element for which the optical power with respect to first wavelength λ₁ and the optical power with respect to second wavelength λ₂ are different may be collimator lens 123 or condenser lens 125, or may be an optical element aside from these lenses. For example, an element in which the optical power is strongly dependent on the wavelength, such as a diffractive optical element, may be provided in the optical path through which both the first light and the second light pass.

Alternatively, a configuration may be adopted in which the optical power of collimator lens 123 is approximately the same for the first light and the second light, and the optical power of another optical element is made to have a greater difference with respect to the first light and the second light. In the case of adopting this configuration, when the first light and the second light emitted from end 161 of optical fiber 16 are made incident on collimator lens 123, both of these are converted into parallel light (collimated light). In this case, due to the change in the relative positions of movable component 11 and movable component 12, calculation of the proportion of each of the first light and the second light returning to end 161 of optical fiber 16 becomes easier, resulting in the advantage of device design and adjustment being easier.

The relative position of movable component 12 with respect to movable component 11 is variable. Guide mechanism 120a of movable component 12 restricts the movement of movable component 11 to the up-down direction. Air supplier 50 is connected to movable component 11. The movement of movable component 11 can be performed smoothly due to the air supplied from air supplier 50.

In the present embodiment, movable component 11 and movable component 12 are coupled to each other by means of spring 15. Spring 15 is an example of the elastic body included in measurement device 1. Spring 15 applies force to movable component 11 in the direction that movable component 11 is pressed against the measurement target (specifically the downward direction). Consequently, contact between stylus 111 and the measurement target is more easily secured, which allows for enhancing measurement reliability.

Measurement device 1 may include rubber, being another example of the elastic body, instead of spring 15. Furthermore, measurement device 1 may not include the elastic body. For example, movable component 11 and movable component 12 may be coupled to each other by means of a mechanism that utilizes a magnet or the like.

### Driving Mechanism

Driving mechanism 13 adjusts the position of movable component 12. Specifically, driving mechanism 13 receives a control signal from controller 14 and changes the position of movable component 12. Driving mechanism 13 is, for example, a linear motor or the like, but is not particularly limited as long as it is capable of adjusting the position of movable component 12.

### Controller

Controller 14 controls driving mechanism 13. Controller 14 is a control signal emitter that generates a control signal that is outputted to driving mechanism 13.

Specifically, controller 14 causes driving mechanism 13 to adjust the position of movable component 12, based on the intensities of the first reflected light and the second reflected light that have entered light entry point 122. More specifically, controller 14 calculates the relative positions of movable component 11 and movable component 12 based on the output signals from light intensity measurer 30. Controller 14 calculates the distance and direction to move movable component 12 in order to bring the thus calculated relative positions within the specified range. Further, controller 14 transmits to driving mechanism 13 a control signal for moving movable component 12 in the calculated direction, by the calculated distance. The method for calculating the relative positions of movable component 11 and movable component 12 is described later.

### Optical Fiber

Optical fiber 16 has end 161 and end 162.

End 161 is an example of the first end, and is light emission point 121 included in movable component 12. Furthermore, end 161 is also light entry point 122 included in movable component 12. End 161 is fixed, either directly or via another component, to probe housing 120b, which is an element of probe 10.

End 162 is the end of optical fiber 16 on the side opposite to end 161. End 162 is not fixed to probe housing 120b. End 162 is connected to circulator 19. Circulator 19 is connected to each of one end of optical fiber 17 and one end of optical fiber 18.

Circulator 19 is an example of a directional coupler. Circulator 19 makes light emitted from light source component 20 and guided along optical fiber 17 enter optical fiber 16, and does not allow entry into optical fiber 18. Furthermore, circulator 19 makes reflected light that has entered from light entry point 122 and been guided along optical fiber 16 enter optical fiber 18, and does not allow entry into optical fiber 17. In this way, circulator 19 makes it possible to split the light input and output paths. Using circulator 19 makes it possible to enhance the usage efficiency of the light emitted from light source component 20, the usage efficiency of the reflected light to be measured, and the signal-to-noise ratio.

Note that use of circulator 19 is not required, and a configuration in which a non-directional coupler such as a splitter is used is also possible. Furthermore, for example, instead of optical fibers 16, 17, and 18 and circulator 19, a bifurcated optical fiber may be used, with one of the two ends being fixed to probe housing 120b.

The other end of optical fiber 17 is connected to light source component 20, and light from light source component 20 enters thereinto. Light emitted from light source component 20 is guided along optical fiber 17 and passes through circulator 19, enters from end 162 of optical fiber 16, and is guided along optical fiber 16 and emitted from end 161.

The other end of optical fiber 18 is connected to light intensity measurer 30, and the first reflected light and the second reflected light guided along optical fiber 18 are emitted to light intensity measurer 30.

Note that optical fiber 17 may be a fiber laser in which the optical fiber itself emits light. Alternatively, optical fiber 17 may, as in a fluorescent fiber or a nonlinear optical fiber, have a wavelength-converting function. In this case, optical fiber 17 may emit only light after wavelength conversion, or may emit both light prior to wavelength conversion and light after wavelength conversion. Optical fiber 17 and light source component 20 may thus be a unified body.

Optical fibers 16, 17, and 18 may be single-mode fibers, or may be multi-mode fibers. For example, in the case of optical fiber 16 being a single-mode fiber, light emission point 121 and light entry point 122 can be reduced in size. When light emission point 121 and light entry point 122 are reduced in size, it is possible to create an optical path with low divergence by means of the optical system included in movable component 12. This facilitates building a system in which changes in the quantity of light of light detectors 31a and 31b are sensitive to changes in the relative positions of movable component 11 and movable component 12. The case of optical fiber 16 being the multi-mode fiber has the advantage of light emitted by light source component 20 easily entering end 162 of optical fiber 16. Thus, this is advantageous from the viewpoint of the signal-to-noise ratio.

Furthermore, a polarization-maintaining fiber may be used for each of optical fibers 16, 17, and 18. When the polarization-maintaining fiber is used, it is easy to use a polarizing optical element to split light L used by interferometer 40 and the light used for measurement of the relative positions of movable component 11 and movable component 12.

### Light Source Component

Light source component 20 emits light that is detectable by light intensity measurer 30. The wavelength of the light emitted by light source component 20 is not particularly limited, and for example, as long as the wavelength is made to differ from that of the light used by interferometer 40, the splitting of these lights by optical element 129, which is a dichroic mirror or the like, is easily performed.

In the present embodiment, light source component 20 emits the first light and the second light. Both the spectrum of the first light and the spectrum of the second light are light having a narrow distribution width. The distribution width can be expressed by the wavelength width having a certain intensity or higher. For example, a half-value width is an example of a distribution width. For both the spectrum of the first light and the spectrum of the second light, the distribution width being narrower enables more sensitively changing the quantity of light that enters optical fiber 16 due to changes in the relative positions of movable component 11 and movable component 12. For example, both the half-width value of the spectrum of the first light and the half-width value of the spectrum of the second light are at most 50 nm. Alternatively, both the half-width value of the spectrum of the first light and the half-width value of the spectrum of the second light may be at most 10 nm. For example, a wavelength component having a certain intensity or higher in the first light and a wavelength component having a certain intensity or higher in the second light do not overlap each other. The certain intensity or higher is, for example, half of the peak intensity of each light.

Thus adopting the narrow distribution width in which the spectrum of the first light and the spectrum of the second light are different from each other facilitates splitting the first light and the second light, and enables, with respect to the relative positions of movable component 11 and movable component 12, making the curve representing the intensity of the first light and the curve representing the intensity of the second light sufficiently different from each other. Consequently, it is possible to enhance the accuracy of detecting the relative positions from the difference in the intensity of the first light and the intensity of the second light.

One example of a light source having a narrow distribution width is a laser light source. The laser light source has a small point of emission, which makes it possible to make the light efficiently enter the optical fiber. As the laser light source, for example, a semiconductor laser can be used. The semiconductor laser has the advantages of being small in size and the drive voltage being low. Furthermore, as the laser light source, a gas laser light source or a DPSS (Diode Pumped Solid State) laser may also be used. These laser light sources have the advantages of having narrow wavelength line widths and ease of stabilizing the peak wavelengths. Furthermore, a fiber laser may be used as the laser light source. The fiber laser has the advantage of ease of coupling with the optical fiber. In particular, a single-mode fiber is sometimes difficult to connect with a light source that radiates light in a free space, but in the case of the fiber laser, this is easy. The present disclosure is not dependent upon the principles of laser oscillation; thus, the practitioner of the present disclosure can freely select the laser light source.

As another light source having a narrow spectral width, a luminous tube having a line spectrum derived from atomic transition, such as a high-pressure mercury lamp, may be used. However, practice of the present disclosure does not require a laser light source or a luminous tube, and a light-emitting diode or the like may be used.

As illustrated in FIG. 1, in the present embodiment, light source component 20 includes laser elements 21a and 21b, optical systems 22a and 22b, and light-synthesizing element 23. Laser element 21a is an example of the first laser light source that emits the first light, and is, for example, a semiconductor laser. Laser element 21b is an example of the second laser light source that emits the second light, and is, for example, a semiconductor laser.

Optical system 22a is an optical element for making light that has been emitted from laser element 21a enter light-synthesizing element 23. Optical system 22b is an optical element for making light that has been emitted from laser element 21b enter light-synthesizing element 23. Light-synthesizing element 23 is, for example, a wavelength combiner, a dichroic optical element, or the like. This makes it possible to unify the optical paths of the first light and the second light and make the light enter optical fiber 17. Note that the overlapping of the optical paths may be performed in free space, or may be performed by using an optical fiber element. Note that light source component 20 may not include optical systems 22a and 22b and light-synthesizing element 23.

### Light Intensity Measurer

Light intensity measurer 30 measures the intensities of the first reflected light and the second reflected light that have entered light entry point 122. Specifically, light intensity measurer 30 independently measures each of the intensity of light at first wavelength λ₁ and the intensity of light at second wavelength λ₂. Alternatively, light intensity measurer 30 may measure an intensity ratio of the intensity of light at first wavelength λ₁ and the intensity of light at second wavelength λ₂, or an intensity differential of the intensity of light at first wavelength λ₁ and the intensity of light at second wavelength λ₂.

For example, as shown in FIG. 1, light intensity measurer 30 includes light detectors 31a and 31b, light-splitting element 32, and A/D converter circuits 33a and 33b.

Light-splitting element 32 splits the first reflected light and the second reflected light, which have entered light entry point 122 and been guided along optical fibers 16 and 18. Light-splitting element 32 is, for example, an optical fiber wavelength splitter. In the present embodiment, first wavelength λ₁ and second wavelength λ₂ are separated from each other and can be easily split. Alternatively, light-splitting element 32 may be a dichroic mirror or a dichroic cube. Furthermore, light-splitting element 32 may be a diffraction grating, a prism, or the like.

Alternatively, light-splitting element 32 may include a fiber splitter that is not dependent on wavelength and splits light at a certain intensity ratio, a half-mirror, or the like. An optical filter that, after the optical path of the light guided along optical fiber 18 is thus split in two, allows passage only to first wavelength λ₁ or second wavelength λ₂ may be provided to each of the two optical paths.

Light detector 31a is an example of the first photodiode, and photoelectrically converts the first reflected light into a first signal and outputs the first signal. A/D converter circuit 33a is an example of the first circuit, and performs analog-to-digital conversion on the first signal outputted from light detector 31a. A/D converter circuit 33a outputs the first signal, which has been converted into a digital signal, to controller 14.

Light detector 31b is an example of the second photodiode, and photoelectrically converts the second reflected light into a second signal and outputs the second signal. A/D converter circuit 33b is an example of the second circuit, and performs analog-to-digital conversion on the second signal outputted from light detector 31b. A/D converter circuit 33b outputs the second signal, which has been converted into a digital signal, to controller 14.

Note that the A/D conversion function performed by A/D converter circuits 33a and 33b may be included in controller 14. The configuration of light intensity measurer 30 is not limited to the example illustrated in FIG. 1.

Thus, the present embodiment enables realizing light intensity measurer 30 with the simple configuration of the two light detectors (for example, two photodiodes) 31a and 31b, and the two A/D converter circuits 33a and 33b. In a case of performing spectroscopy on white light with a diffraction grating, a prism, or the like and performing a spectrum measurement with an array detector, providing an A/D converter to each photodiode of the array detector would be difficult. Thus, since it would be necessary to switch between and use a limited number of A/D converters, it would be difficult to calculate the relative positions in short cycles.

In the present embodiment, it is simply necessary to be able to measure only the intensities of the two wavelengths of first wavelength λ₁ and second wavelength λ₂. Thus, the relative positions of movable component 11 and movable component 12 can be calculated in short cycles, and the relative positions can be controlled.

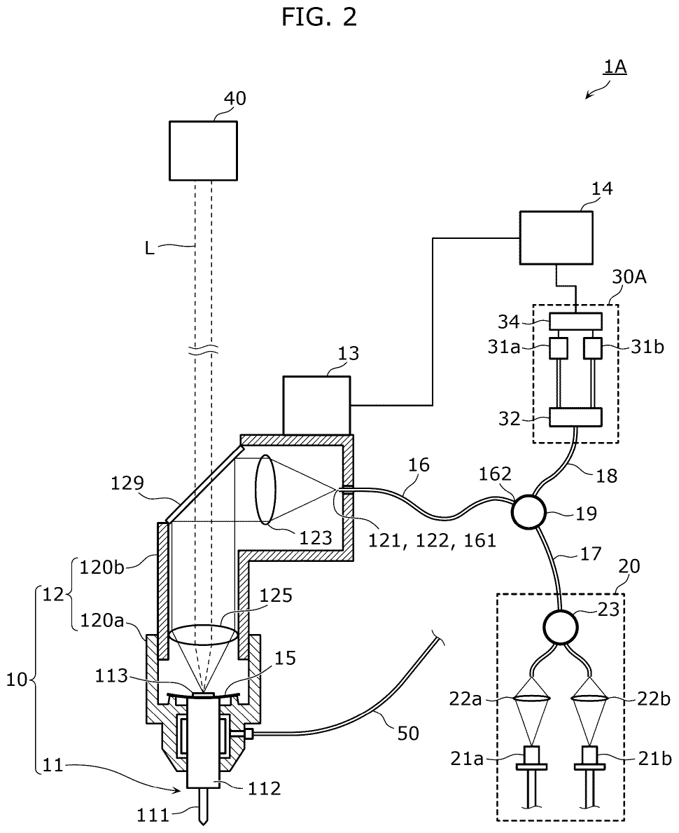

Note that in the example illustrated in FIG. 1, A/D converter circuits 33a and 33b are connected to each of light detectors 31a and 31b, but configuration is not limited thereto. As in light intensity measurer 30A of measurement device 1A illustrated in FIG. 2, differential operation circuit 34 may be connected to the two light detectors 31a and 31b. Here, FIG. 2 illustrates an outline configuration of a measurement device according to a variation of the present embodiment.

Differential operation circuit 34 receives the inputs of the first signal outputted from light detector 31a, and the second signal outputted from light detector 31b. Differential operation circuit 34 calculates the difference between the first signal and the second signal, and transmits a signal representing the calculated difference to controller 14. Differential operation circuit 34 is, for example, embodied as a differential amplifier circuit such as an operational amplifier.

### Interferometer

Interferometer 40 uses light L to measure the position of mirror 113, which is included in movable component 11 of probe 10. The relative position of mirror 113 is fixed with respect to stylus 111. The position of stylus 111, which comes in contact with the measurement target, changes in line with the shape of the measurement target; thus, by measuring the position of mirror 113, it is possible to measure the shape of the measurement target.

Interferometer 40 uses, for example, a wavelength-stabilized He—Ne laser or a frequency-stabilized semiconductor laser as the light source of light L, which is used for measurement. Note that probe 10 may separately include each of a mirror for reflecting light L for interferometer 40, and a mirror for reflecting light for measuring the relative positions of movable component 11 and movable component 12.

### Method for Controlling Relative Positions of Movable Component 11 and Movable Component 12

Next, a method for controlling the relative positions of movable component 11 and movable component 12 is described.

The first light and the second light emitted from light source component 20 are guided along optical fiber 17, circulator 19, and optical fiber 16, and are emitted from end 161, which serves as light emission point 121. The first light and the second light emitted from end 161 of optical fiber 16 are converted by collimator lens 123 into parallel light, and transmitted within probe housing 120b. Specifically, the parallel light from collimator lens 123 is reflected by optical element 129 and becomes incident on condenser lens 125.

By means of condenser lens 125, the first light and the second light, which are parallel light, are converted into light that is condensed to the region of mirror 113 and reflected by mirror 113. The reflected light reflected by mirror 113 (in other words, the first reflected light and the second reflected light) once again pass through condenser lens 125, become parallel light and are transmitted within probe housing 120b, once again enter collimator lens 123, and are then condensed to the region near end 161 of optical fiber 16.

The optical paths of the first light and the second light vary in accordance with the relative positions of condenser lens 125 included in movable component 12, and mirror 113 included in movable component 11. In other words, the optical paths of the first light and the second light are dependent upon the relative positions of movable component 11 and movable component 12.

As more light is condensed by collimator lens 123 to the region near end 161 of optical fiber 16, the quantity of light that enters the interior of optical fiber 16 increases. Thus, the light intensity measured by light intensity measurer 30 becomes greater. The position of the light condensed by collimator lens 123 is dependent upon the relative positions of condenser lens 125 and mirror 113.

Thus, for example, if movable component 12 is controlled such that the intensity of the first light measured by light intensity measurer 30 is constantly at the maximum, the relative positions of movable component 11 and movable component 12 can be kept constant.

At this time, in the case of using only the intensity of the first light, when the intensity is not at the maximum, it will not be possible to assess which way to drive movable component 12. Accordingly, measurement device 1 according to the present embodiment involves using not only the first light, but also the second light, which has a different peak wavelength.

Here, the optical system, which is in the optical path at which the first light and the second light exit from end 161 of optical fiber 16 and are once again condensed to end 161 of optical fiber 16 as the first reflected light and the second reflected light, includes at least one optical element that has different optical power at first wavelength λ₁ and second wavelength λ₂. Due to this configuration, it is possible to change the relative positions of movable component 11 and movable component 12 when the intensity of first wavelength λ₁ detected by light intensity measurer 30 is at the maximum, and the relative positions of movable component 11 and movable component 12 when the intensity of second wavelength λ₂ detected by light intensity measurer 30 is at the maximum.

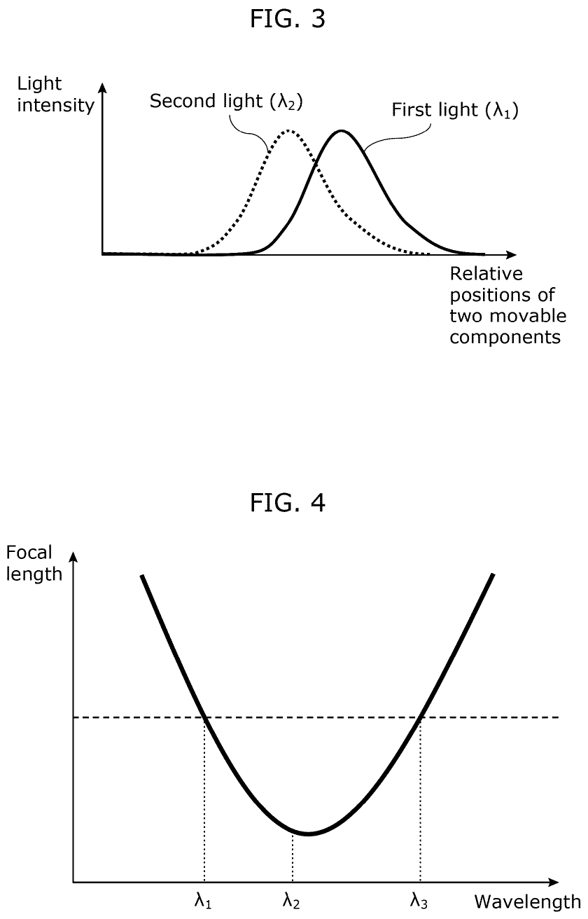

FIG. 3 is a graph illustrating the relationship between the relative positions of the two movable bodies and light intensity. Specifically, FIG. 3 illustrates a schematic diagram of the relationship between the relative positions of mirror 113 included in movable component 11 and condenser lens 125 included in movable component 12, and the intensities of the first light and the second light. The light intensities of the first light and the second light are at the maximum when end 161, which serves as light emission point 121, and end 161, being the light entrance point via the optical system, are at relative positions so as to be optically conjugate. As illustrated in FIG. 3, since, of the elements constituting the optical system, at least one optical element has different optical power at first wavelength λ₁ and second wavelength λ₂, the relative positions when the intensity of first wavelength λ₁ is at the maximum, and the relative positions when the intensity of second wavelength λ₂ is at the maximum are different.

Note that FIG. 3 illustrates a case in which the optical power of condenser lens 125 at first wavelength λ₁ is greater than the optical power of condenser lens 125 at second wavelength λ₂. In other words, the focal length of condenser lens 125 at second wavelength λ₂ is shorter than the focal length of condenser lens 125 at first wavelength λ₁, indicating being conjugate at second wavelength λ₂ at closer relative positions than the relative positions that result in being conjugate at first wavelength λ₁.

For example, in a case in which the relative positions are controlled such that the intensity of the light at first wavelength λ₁ is at the maximum, when both the intensity of the light at first wavelength λ₁ and the intensity of the light at second wavelength λ₂ have decreased, controller 14 controls driving mechanism 13 so as to bring the relative positions of movable component 11 (specifically mirror 113) and movable component 12 (specifically condenser lens 125) closer together. Furthermore, in a case in which, while the intensity of the light at first wavelength λ₁ decreases, the intensity of the light at second wavelength λ₂ increases, controller 14 controls driving mechanism 13 so as to make the relative positions of movable component 11 and movable component 12 further apart. Consequently, the relative positions of movable component 11 and movable component 12 can be kept within a certain range.

Alternatively, controller 14 may control driving mechanism 13 based on the difference between the intensity of the light at first wavelength λ₁ and the intensity of the light at second wavelength λ₂. For example, controller 14 can control driving mechanism 13 so as to confine movable component 11 and movable component 12 within relative positions at which the difference in intensities is 0. In this case, when the difference in the intensities is positive, controller 14 controls driving mechanism 13 such that the relative positions of movable component 11 and movable component 12 are brought closer together. When the difference in the intensities is negative, controller 14 controls driving mechanism 13 such that the relative positions of movable component 11 and movable component 12 are made further apart. Consequently, the relative positions of movable component 11 and movable component 12 can be kept within a certain range. Such controlling is one example, and other controlling may be performed.

Note that the relative positions of movable component 11 and movable component 12 may be controlled to be in positions at which interferometer 40 can perform measurement the best. In the case of a configuration in which light L used by interferometer 40 is condensed by condenser lens 125 and reflected by mirror 113, mirror 113 is controlled to be arranged at the focal position of condenser lens 125 at the wavelength of light L used by interferometer 40.

This can be realized by making the focal length of condenser lens 125 at wavelength (third wavelength) λ₃ of light L used by interferometer 40 approximately equal to the focal length of condenser lens 125 at one of first wavelength λ₁ or second wavelength λ₂, and controlling the relative positions such that the detection intensity of light L having the approximately equal wavelength is at the maximum.

The following two methods can be used to make the focal length of condenser lens 125 at wavelength λ₃ of light L used by interferometer 40 approximately equal to the focal length of condenser lens 125 at one of first wavelength λ₁ or second wavelength λ₂.

The first method is a method that involves making the wavelengths themselves closer.

One of first wavelength λ₁ or second wavelength λ₂ is close to wavelength λ₃ of light L used by interferometer 40. In this case, the focal length of condenser lens 125 in probe 10 at to wavelength λ₃ of light L used by interferometer 40 becomes close to the focal length thereof at one of first wavelength λ₁ or second wavelength λ₂. For example, the difference between wavelength λ₃ and one of either first wavelength λ₁ or second wavelength λ₂ is at most 5 nm when wavelength λ₃ is less than 500 nm, and at most 10 nm when λ₃ is at least 500 nm. Wavelength λ₃ may be equal to one of first wavelength λ₁ or second wavelength λ₂.

When the first light or the second light enters interferometer 40, a negative effect may be exerted on the measurement of the measurement target. Furthermore, when light L used by interferometer 40 enters light intensity measurer 30, a negative effect may be exerted on the measurement of the relative positions of movable component 11 and movable component 12.

Thus, in order to prevent the entry of undesired light, movable component 12 may be provided with a mechanism by which undesired light is not allowed to enter. This mechanism may be provided to condenser lens 125 or optical element 129, or may be provided as an optical element that is different from condenser lens 125 or optical element 129. For example, in a case in which a polarized state of the first light and the second light differs from a polarized state of light L used by interferometer 40, a polarizing optical element can be used to pass through one light and block the other light.

Alternatively, it is not necessary to make wavelength λ₃ of light L used by interferometer 40 completely match first wavelength λ₁ or second wavelength λ₂, and there may be a slight difference. For example, depending upon glass material selection and shape design of the lens, the focal length is approximately the same if the wavelength difference is about 10 nm; more specifically, lenses having a difference in focal length that is within 5% can be designed.

Furthermore, in a filter that utilizes a dielectric multilayer film, it is easy to configure a bandpass filter with a transmissive width of at most 10 nm, or a notch filter with a rejection width of at most 10 nm. For example, a bandpass filter that allows the passage of wavelength λ₃ of light L used by interferometer 40 and blocks first wavelength λ₁ and second wavelength λ₂ may be arranged in the optical path toward interferometer 40, and a notch filter that blocks wavelength λ₃ of light L used by interferometer 40 and allows the passage of first wavelength λ₁ and second wavelength λ₂ may be arranged in the optical path toward light intensity measurer 30. This makes it possible to prevent the mixing in of light that is undesirable to each of interferometer 40 and light intensity measurer 30.

The second method is a method that involves using a lens that has the same focal length at a plurality of wavelengths.

A lens obtained by combining a plurality of glass materials having different refractive index dispersions can be made to have the same focal length at a plurality of wavelengths. As an example, the wavelength dependency of the focal length of an achromatic lens obtained by combining two glass materials is illustrated in FIG. 4. FIG. 4 is a graph illustrating the relationship between the wavelength of entering light and the focal length of the achromatic lens. For example, an achromatic lens having the characteristics illustrated in FIG. 4 is used as condenser lens 125.

The focal length of the achromatic lens indicates the characteristic of basically having one pole with respect to wavelengths. Thus, aside from the focal length at the pole, there are two wavelengths having the same focal length. In this instance, wavelength λ₃ of light L used by interferometer 40 is adopted as one wavelength, and the wavelength of the first light or the second light is adopted as the other wavelength. This makes it possible for the focal length of condenser lens 125 to be approximately the same at wavelength λ₃ and one of first wavelength λ₁ or second wavelength λ₂, while the mutual wavelengths greatly differ from each other.

In the example illustrated in FIG. 4, first wavelength λ₁ is a wavelength having the same focal length as that of wavelength λ₃ of light L used by interferometer 40, and the focal length at second wavelength λ₂ is shorter than these. Of course, a combination other than these may be adopted. For example, the focal length at second wavelength λ₂ may be longer than the focal length at wavelength λ₃ of light L used by interferometer 40.

In the case of using an achromatic lens, since it is possible to make the wavelengths greatly differ from each other, it is easy to split light by means of a dichroic mirror or a dielectric multilayer film filter. For example, if both first wavelength λ₁ and second wavelength λ₂ are selected to be shorter than or longer than wavelength λ₃ of light L used by interferometer 40, it is easy to use a dichroic mirror to split light L used by interferometer 40 from the first light and the second light.

Note that it is not necessary for the focal length at wavelength λ₃ of light L used by interferometer 40 to completely match the focal length at first wavelength λ₁ or the focal length at second wavelength λ₂. As long as the difference in the focal lengths is sufficiently small, the effects can be obtained. Specifically, it is only necessary for the optical power of the optical element at wavelength λ₃ to be approximately equal to the optical power of the optical element at wavelength λ₁ or wavelength λ₂.

### Effects

Next, the effects of measurement device 1 according to the present embodiment are described while presenting a comparison to conventional optical probe 10x, illustrated in FIG. 6.

Specifically, in the conventional example, semiconductor laser 21x, two light detectors 31ax and 31bx, a beam splitter, and two pinholes are provided to movable component 12x in order to measure the relative positions of movable component 11x and movable component 12x. In contrast, in measurement device 1, instead of including the configuration having these, end 161 of optical fiber 16 is connected to movable component 12. The advantages resulting from such a configuration are explained below.

The first advantage is the reduction in size and weight of movable component 12.

In order to inhibit deterioration resulting from ambient air and the like, semiconductor laser 21x is typically contained inside a package that has a metal housing with a size of about several mm, and a glass window. On the other hand, end 162 of optical fiber 16, which serves as light emission point 121, does not necessitate a metal housing or a glass window. Thus, movable component 12 can be reduced in weight by omitting these.

Furthermore, with regard to the size as well, in the case of optical fiber 16, the diameter of end 161 thereof can be made 1 mm or less. Thus, utilizing end 162 of optical fiber 16, instead of semiconductor laser 21x, as light emission point 121 makes it possible to reduce the size of movable component 12.

Furthermore, optical fiber 16 radiates light from a round cross section that is highly symmetrical and small in diameter. In particular, a single-mode fiber has an especially small cross section. Thus, optical fiber 16 makes it possible to radiate light having uniform spatial modes. Therefore, the light radiated from optical fiber 16 can be inhibited from divergence even if a small, lightweight lens having a short focal length is used as collimator lens 123 for conversion into collimated light having a small diameter.

The ability to reduce the diameter of the light makes it possible to reduce in size each of components such as the lens, prism, mirror, and the like included in the optical system fixed to movable component 12. This consequently makes it possible to reduce the size and weight of the optical system as a whole, which allows for contribution to reducing the size of movable component 12.

Furthermore, the optical system included in movable component 12 may include a GRIN (Graded-Index: refractive index distribution-type) lens fixed to end 161 of optical fiber 16. Using a GRIN lens allows for omitting collimator lens 123, making it possible to further reduce the size and weight of movable component 12.

Light that has uniform spatial modes can be condensed within a smaller range. This means that pinholes having smaller hole diameters can be used as the pinholes for detecting the relative positions of movable component 11 and movable component 12. Alternatively, this means that the focal length of the lenses that condense the light toward the pinholes can be reduced in size. Consequently, these also contribute to reducing the size and weight of movable component 12.

On the other hand, semiconductor laser 21x, which is the conventional light source, has spatial broadening and radiates light that is asymmetrical in the up-down direction and the left-right direction. Thus, the collimated light, which is small in diameter, is susceptible to divergence, and it is difficult to reduce the size of the optical system that includes the lens and the like.

Furthermore, similarly to the case of semiconductor laser 21x, it is also necessary for light detectors 31ax and 31bx to have diameters of about several mm in size for sealing. In contrast, in the present embodiment, light detectors 31a and 31b are disposed separately from movable component 12, and end 161 of optical fiber 16 is connected to movable component 12. In this sense as well, movable component 12 can be reduced in size and weight. Furthermore, in the present embodiment, a light-shielding member having a pinhole can be omitted. Thus, further reduction in size and weight can be achieved.

The second advantage is the reduction of wires.

Operating semiconductor laser 21x requires connection to a power source using different wires for each of the anode and the cathode. In other words, it is necessary to connect a minimum of two wires to semiconductor laser 21x, which is fixed to movable component 12x. In the case of also using an output monitor attached inside a typical semiconductor laser 21x, one further wire is necessary. Light detectors 31ax and 31bx similarly require power lines and signal lines. As the wires connected to movable component 12x become more numerous, reducing the size of movable component 12x becomes more difficult.

In contrast, in the present embodiment, light source component 20 and light intensity measurer 30 are provided separately from movable component 12. It is only necessary to connect one optical fiber 16 to movable component 12 for light emission. Thus, movable component 12 can be reduced in size.

The third advantage is the reduction of heat generation.

With semiconductor laser 21x, generally less than half of the power consumed is converted into light. The remainder of the power is released as heat. The waste heat from semiconductor laser 21x, which is fixed to movable component 12x, causes a rise in temperature inside movable component 12x. The rise in temperature inside movable component 12x causes the refractive index of the internal air to fluctuate and consequently causes what is referred to as flickering. Light L, the distance measurement mechanism for the shape measurement of the measurement target, also passes through the interior of movable component 12x; thus, this flickering negatively affects the accuracy of the shape measurement of the measurement target.

Conversely, in the present embodiment, light source component 20, the principal source of heat generation, is not provided to movable component 12. With optical fiber 16, which is connected to movable component 12, heat generation of the components fixed to movable component 12 can be largely ignored. Thus, the effect of heat can be greatly reduced, making it possible to inhibit deterioration of the accuracy of measuring the measurement target.

The fourth advantage is ease of replacement.

Semiconductor laser 21x generally has a lifespan of about 10,000 hours. This lifespan equates to about one year in the case of continuous lighting. When semiconductor laser 21x deteriorates, it becomes difficult to measure the relative positions of movable component 11x and movable component 12x; consequently, it becomes necessary to replace semiconductor laser 21x.

In the case in which semiconductor laser 21x is fixed to movable component 12x, it is necessary, each time a replacement is made, to perform adjustment work on the optical system attached to movable component 12x. Since the optical system of movable component 12x is partially shared with interferometer 40, which is for the shape measurement of the measurement target, attentive care must be given for this adjustment.

Meanwhile, in the present embodiment, laser element 21 is disposed separately from movable component 12. In this case, even when replacing laser element 21, adjustment is only necessary for the optical system coupled to optical fiber 16. Thus, replacement adjustment work can be made easier.

### Embodiment 2

Next, Embodiment 2 will be described. In the measurement device according to the present embodiment, a light source that is able to simultaneously generate both the first light and the second light is used as the light source component.

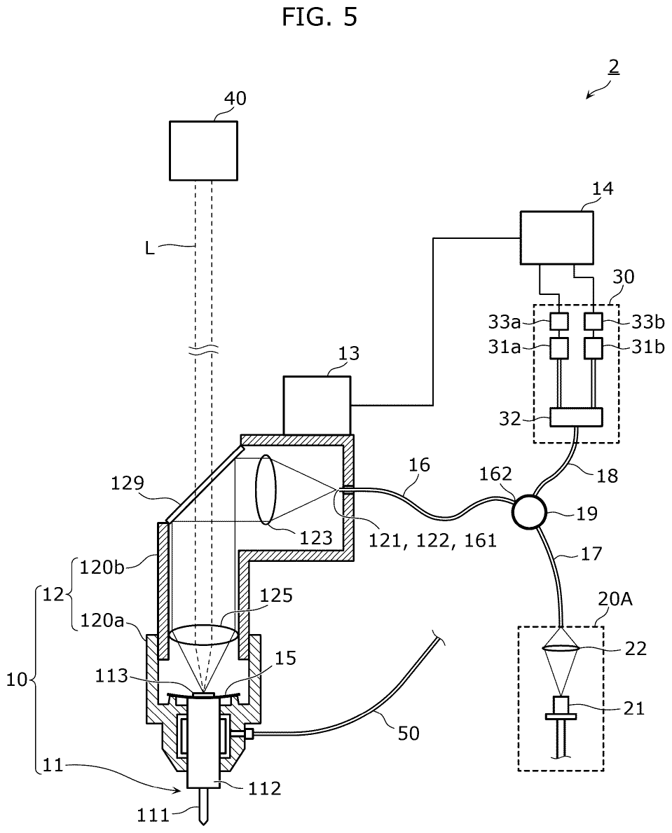

FIG. 5 illustrates an outline configuration of the measurement device according to the present embodiment. As illustrated in FIG. 5, compared to measurement device 1 according to Embodiment 1, measurement device 2 includes light source component 20A instead of light source component 20. The rest of the configuration is the same as in Embodiment 1. Hereinafter, the description will focus on the points of difference from Embodiment 1, and explanation of the points in common will be omitted.

Light source component 20A includes laser element 21 and optical system 22. Laser element 21 is an example of the light source that simultaneously generates the first light and the second light. Specifically, laser element 21 is an example of a laser light source that includes a first active region that emits a first light and a second active region that emits a second light. Optical system 22 is an element that makes the first light and the second light emitted from laser element 21 enter optical fiber 17. For example, optical system 22 is a condenser lens. Optical system 22 may be a filter that allows the passage of only desired wavelengths.

Laser element 21 is, for example, a semiconductor laser capable of simultaneous oscillation of a plurality of wavelengths. For example, a dual wavelength laser for CD and DVD can be used as laser element 21. In the dual wavelength laser for CD and DVD, a first active region that oscillates at about 650 nm and a second active region that oscillates at about 780 nm are formed in a single chip. The positions of the active regions that emit the light at each wavelength are spatially separated, but it is relatively easy for both lights to enter the same core, in a multi-mode fiber, with one optical system.

Note that the light source capable of simultaneously generating the first light and the second light is not limited to being a semiconductor laser.

A gas laser light source may be used instead of laser element 21. For example, a gas laser such as an Ar laser or the like has a plurality of discrete oscillation wavelengths. Thus, by carefully devising, e.g., the design of the resonator, simultaneous oscillation of a plurality of wavelengths is possible. For example, a multi-wavelength Ar laser capable of simultaneously oscillating 457 nm light, 488 nm light, and 514 nm light is known. The desired two wavelengths among these wavelengths can be selected and used. Of course, two desired wavelengths of a multi-wavelength gas laser having other oscillation wavelengths may be selected.

Furthermore, a luminous tube that uses gas may also be used instead of laser element 21. The luminous tube that uses gas has a plurality of discrete emission lines. For example, a high-pressure mercury lamp has strong emission lines at each of 405 nm and 436 nm. By using an optical filter, a prism, a diffraction grating, or the like, light of a certain wavelength can be extracted.

### Variation

In Embodiment 2, the example in which one light source simultaneously oscillated the first light and the second light was shown, but a method involving the use of fluorescence is a method of generating, from one light source, light having another wavelength spectrum.

Fluorescence is a phenomenon in which a phosphor is excited by a certain wavelength and emits light having a longer wavelength. Examples of phosphors include aromatic molecules and other organic molecules, direct transition-type semiconductors and quantum dots including these, glass or crystals including rare earths and the like, and the like. Of these, phosphors in which quantum dots are used and phosphors including rare earths result in fluorescence with a narrow spectral width, and are thus useful for the measurement apparatus of the present disclosure. However, the measurement device of the present disclosure can be practiced even with light having a wide spectral width. Furthermore, it is also possible to narrow the spectral width by using a bandpass filter or the like.

Fluorescence generation by phosphors may be performed in free space. Alternatively, fluorescence generation may be performed in an optical fiber that includes phosphors in a core or a cladding layer. In the case of a configuration in which wavelength conversion is performed within an optical fiber, it is not necessary to make two lights separately enter one core, whereby device configuration and adjustments are made simple.

Furthermore, a wavelength conversion method other than phosphors may be used. For example, a nonlinear optical crystal may be used to generate, from light having a certain wavelength, light having a different wavelength by means of a phenomenon such as SHG (second harmonic generation). Alternatively, SFG (sum-frequency generation) may be used to generate, from a combination of lights having at least two wavelengths, light having a different set of wavelengths. Alternatively, OPO (optical parametric oscillation) may be used to obtain two wavelengths by splitting light of one wavelength in two. If the nonlinear optical crystal is, for example, waveguide-type PPLN (periodically poled lithium niobate) or the like, the nonlinear optical crystal can be easily arranged in the path of an optical fiber.

### Other Embodiments

The measurement device according to one or a plurality of aspects has been described based on the embodiments, but the present disclosure is not limited to these embodiments. Forms obtained by making various modifications to the above embodiments that can be conceived by those skilled in the art, as well as forms obtained by combining constituent elements in different embodiments, without materially departing from the spirit of the present disclosure, are thus included in the scope of the present disclosure.

For example, in the measurement device according to each of the exemplary embodiments, movable component 11 and movable component 12 may be completely uncoupled. The relative positions of movable component 11 and movable component 12 in the up-down direction may be variable by means of the weight of movable component 11 itself. In this case, the weight of movable component 11 itself can be effectively utilized by adjusting the orientation of the measurement device such that the up-down direction matches the vertical direction. Note that a regulator such as a projection that regulates the position of movable component 11 may be provided so that movable component 11 does not detach from movable component 12.

Furthermore, the example in which the light entry point and the light emission point are the same and are an end of one optical fiber has been described, but the present disclosure is not limited thereto. The light entry point and the light emission point may be different. For example, an end of a first optical fiber serving as the light entry point and an end of a second optical fiber serving as the light emission point may be connected to movable component 12.

Furthermore, the present disclosure may be realized as a control system for, or a method for controlling a movable body included in a measurement device. The control system is, for example, realized by means of one or more computer devices. Specifically, the control system includes a controller that controls a driving mechanism, which adjusts the position of a second movable body having a light emission point, a light entry point, and an optical system. First light and second light emitted from the light emission point are emitted, via the optical system, onto a reflector included in a first movable body. First reflected light and second reflected light reflected from the reflector each enter the light entry point via the optical system. The controller causes the driving mechanism to adjust the position of the second movable component, based on the intensities of the first reflected light and the second reflected light that have entered the light entry point. A first wavelength that is a peak wavelength of the first light is different from a second wavelength that is a peak wavelength of the second light. The optical power of the optical system at the first wavelength is different from the optical power of the optical system at the second wavelength.

Furthermore, the present disclosure may be realized as a non-contact-type measurement device. Specifically, a first movable body of the measurement device may not come into contact with a measurement target when measuring the measurement target. For example, an interferometer may be configured such that light is emitted onto the surface of the measurement target and reflected light that is the light from the measurement target is received.

Note that the one or more computer devices include, for example: nonvolatile memory in which program(s) are stored; volatile memory that is a temporary storage area for executing program(s); input/output port(s); a processor for executing program(s); and the like. Furthermore, the control system may be an FPGA (field-programmable gate array) that allows for programming or a reconfigurable processor in which connection and settings of circuit cells in an LSI can be reconfigured. The functions executed by the control system may be executed by means of software, or may be executed by means of hardware.

Furthermore, the method for controlling the movable body included in the measurement device includes a step of controlling a driving mechanism, which adjusts the position of a second movable body having a light emission point, a light entry point, and an optical system. First light and second light emitted from the light emission point are emitted, via the optical system, onto a reflector included in a first movable body. First reflected light and second reflected light reflected from the reflector each enter the light entry point via the optical system. In the controlling step, the controller causes the driving mechanism to adjust the position of the second movable component, based on the intensities of the first reflected light and the second reflected light that have entered the light entry point. A first wavelength that is a peak wavelength of the first light is different from a second wavelength that is a peak wavelength of the second light. The optical power of the optical system at the first wavelength is different from the optical power of the optical system at the second wavelength.

Furthermore, the present disclosure may be realized as a program for making a computer execute the method for controlling the movable body included in the measurement device. Furthermore, the present disclosure may be realized as a non-transitory recording medium that stores the program.

Furthermore, various modifications, replacement, addition, and omission may be carried out on each of the foregoing exemplary embodiments within the scope of the claims or its equivalents.

### INDUSTRIAL APPLICABILITY

The present disclosure can be used in various measurement devices for, e.g., testing of industrial products that necessitate highly accurate distance measurement.

1. A measurement device comprising:
a first movable body including a reflector;
a second movable body including a light emission point, a light entry point, and an optical system;
a driving mechanism that adjusts a position of the second movable body; and
a controller that controls the driving mechanism, wherein
first light and second light that are emitted from the light emission point are emitted onto the reflector via the optical system,
first reflected light and second reflected light enter the light entry point via the optical system, the first reflected light being reflected light of the first light from the reflector, the second reflected light being reflected light of the second light from the reflector,
the controller causes the driving mechanism to adjust the position of the second movable body, based on an intensity of each of the first reflected light and the second reflected light that have entered the light entry point,
a first wavelength that is a peak wavelength of the first light is different from a second wavelength that is a peak wavelength of the second light, and
an optical power of the optical system at the first wavelength is different from an optical power of the optical system at the second wavelength.

2. The measurement device according to claim 1, comprising:
an optical fiber, wherein
the light emission point and the light entry point are both a first end of the optical fiber.

3. The measurement device according to claim 1, wherein
a wavelength component having a certain intensity or higher in the first light and a wavelength component having a certain intensity or higher in the second light do not overlap each other.

4. The measurement device according to claim 1, wherein
light used to measure a target enters the optical system,
a third wavelength that is a peak wavelength of the light used to measure the target is different from both the first wavelength and the second wavelength, and
an optical power of the optical system at the third wavelength is approximately equal to one of the optical power of the optical system at the first wavelength or the optical power of the optical system at the second wavelength, and is different from an other of the optical power of the optical system at the first wavelength or the optical power of the optical system at the second wavelength.

5. The measurement device according to claim 4, comprising:
an interferometer that produces interference in the light used to measure the target.

6. The measurement device according to claim 1, comprising:
a light intensity measurer that measures an intensity of each of the first reflected light and the second reflected light that have entered the light entry point.

7. The measurement device according to claim 6, wherein
the light intensity measurer includes:
a first photodiode that photoelectrically converts the first reflected light into a first signal and outputs the first signal;
a second photodiode that photoelectrically converts the second reflected light into a second signal and outputs the second signal;
a first circuit that performs analog-to-digital conversion on the first signal; and
a second circuit that is different from the first circuit and performs analog-to-digital conversion on the second signal.

8. The measurement device according to claim 6, wherein
the light intensity measurer includes:
a first photodiode that photoelectrically converts the first reflected light into a first signal and outputs the first signal;
a second photodiode that photoelectrically converts the second reflected light into a second signal and outputs the second signal; and
a differential operation circuit that receives inputs of each of the first signal and the second signal.

9. The measurement device according to claim 2, comprising:
a light source component, wherein
light emitted from the light source component enters from an end of the optical fiber on a side opposite to the first end, is guided along the optical fiber, and is emitted from the first end as the first light and the second light.

10. The measurement device according to claim 9, wherein
the light source component includes:
a first laser light source that emits the first light; and
a second laser light source that is different from the first laser light source and emits the second light.

11. The measurement device according to claim 9, wherein
the light source component is a laser light source that includes:
a first active region that emits the first light; and
a second active region that emits the second light.

12. The measurement device according to claim 9, wherein
the light source component is a gas laser light source that emits 5 the first light and the second light.

13. The measurement device according to claim 1, wherein
the optical system Includes an achromatic lens.
